(19) United States
(12) Patent Application Publication
(10) Pub. No.: US 2026/0225581 A1
(43) Pub. Date: Aug. 6, 2026

(54) PARKING ASSIST SYSTEM

(71) Applicant: AISIN CORPORATION, Kariya, Aichi (JP)

(72) Inventors: Atsuto OGINO, Kariya-shi, Aichi-ken (JP); Kota SHIKAWA, Kariya-shi, Aichi-ken (JP)

(73) Assignee: AISIN CORPORATION, Kariya, Aichi (JP)

(21) Appl. No.: 19/149,770

(22) PCT Filed: Mar. 22, 2024
(86) PCT No.: PCT/JP2024/011203

§ 371 Date: Jul. 21, 2025

(30) Foreign Application Priority Data
Mar. 30, 2023 (JP) 2023-055578

(51) Int. Cl. B60W 30/06; B60W 30/14

(52) U.S. Cl. CPC B60W 30/06; B60W 30/143; B60W 2520/105

(57) ABSTRACT

Speed control processing by a vehicle control unit includes: first operation processing OP1 that is performed in a first range H1 that is a part of a movement route to a target parking position Pt and includes the target parking position Pt; and second operation processing OP2 performed in a second range H2 that is farther from the target parking position Pt than the first range H1 is. In the second operation processing OP2, a target speed V is decreased at a constant deceleration, and in the first operation processing OP1, the target speed V is decreased at a deceleration whose absolute value decreases as a remaining distance L, on the movement route, to the target parking position Pt becomes smaller.

### CROSS REFERENCE TO RELATED APPLICATIONS

This is a National Stage Application of International Application No. PCT/JP2024/011203 filed Mar. 22, 2024, claiming priority based on Japanese Patent Application No. 2023-055578 filed Mar. 30, 2023.

### TECHNICAL FIELD

The present disclosure relates to a parking assist system that performs vehicle control for moving a vehicle to a parking space.

BACKGROUND ART JP 2021-62743 A discloses a parking assist system that performs vehicle control for moving a vehicle to a parking space by controlling a driving force and a braking force acting on the wheel. In this parking assist system, the vehicle is accelerated from a guidance start position, the vehicle is caused to travel while maintaining a steady speed after reaching the steady speed, the vehicle is decelerated at a first deceleration when a remaining distance to the target parking position reaches a first predetermined distance, the vehicle is further decelerated at a second deceleration greater than the first deceleration when the remaining distance reaches a second predetermined distance shorter than the first predetermined distance, and the vehicle is stopped when the vehicle reaches the target parking position.

### CITATIONS LIST

### Patent Literature

Patent Literature 1: JP 2021-62743 A

### SUMMARY OF THE DISCLOSURE

### Technical Problems

In the parking assist system described above, the vehicle is decelerated at a relatively large deceleration on the side closer to the target parking position. As a result, it is possible to quickly lower the traveling speed of the vehicle and quickly complete the parking assistance, but since the traveling speed is rapidly reduced on the side closer to the target parking position, shock such as vibration at the time of stopping the vehicle tends to be large. When the vehicle stops from a sufficiently low speed, such a shock is relatively small, but it can be thought that some occupants feel uncomfortable about the shock.

In view of the above background, it is desired to achieve a parking assist system capable of more smoothly stopping a vehicle at a target parking position when performing vehicle control for moving the vehicle to a parking space.

### Solutions to Problems

A parking assist system in view of the above includes: a vehicle control unit that performs vehicle control for moving a vehicle including a wheel to a parking space by controlling a driving force and a braking force acting on the wheel; and a speed detection unit that detects a real speed that is an actual speed of the vehicle. The vehicle control unit performs: speed control processing of controlling a speed of the vehicle by calculating a target speed for moving the vehicle to a target parking position set in the parking space and then stopping the vehicle; and drive control processing of controlling the driving force and the braking force acting on the wheel so as to cause the real speed to become closer to the target speed. The speed control processing includes: first operation processing performed in a first range that is a part of a movement route to the target parking position and includes the target parking position; and second operation processing performed in a second range that is farther, on the movement route, from the target parking position than the first range is. The vehicle control unit decreases, in the second operation processing, the target speed at a constant deceleration, and the vehicle control unit decreases, in the first operation processing, the target speed at a deceleration whose absolute value becomes smaller as a remaining distance becomes smaller, the remaining distance being a distance on the movement route and being between the target parking position and the vehicle.

With the present configuration, in the second range, it is possible to cause the vehicle to come closer to the target parking position while rapidly decelerating the vehicle at a constant deceleration. Then, in the first range closer to the target parking position than the second range is, it is possible to gradually decrease the deceleration of the vehicle according to the remaining distance as the vehicle comes closer to the target parking position. Therefore, the change in the real speed of the vehicle in the vicinity of the target parking position is suppressed to be small, and the vibration when the vehicle stops at the target parking position is suppressed to be small, so that a smooth vehicle stop operation is easily achieved. That is, with the present configuration, it is possible to achieve a parking assist system capable of more smoothly stopping a vehicle at a target parking position when performing vehicle control for moving the vehicle to a parking space.

Additional features and advantages of the parking assist system will become apparent from the following description of exemplary and non-limiting embodiments described with reference to the drawings.

### BRIEF DESCRIPTION OF DRAWINGS

FIG. 1 is an explanatory diagram illustrating an example of parking assist.

FIG. 2 is an explanatory diagram illustrating another example of the parking assist.

FIG. 3 is a schematic block diagram illustrating an example of a system configuration of a vehicle including a parking assist system.

FIG. 4 is a schematic control block diagram of vehicle control by a vehicle control unit.

FIG. 5 is a block line diagram illustrating an example of feedback control.

FIG. 6 is a block line diagram illustrating an example of a speed feedback controller.

FIG. 7 is a block line diagram schematically illustrating a principle of deceleration control based on a remaining distance.

FIG. 8 is a diagram illustrating an example of changes in a vehicle speed, a remaining distance to a target parking position, and acceleration.

### DESCRIPTION OF EMBODIMENTS

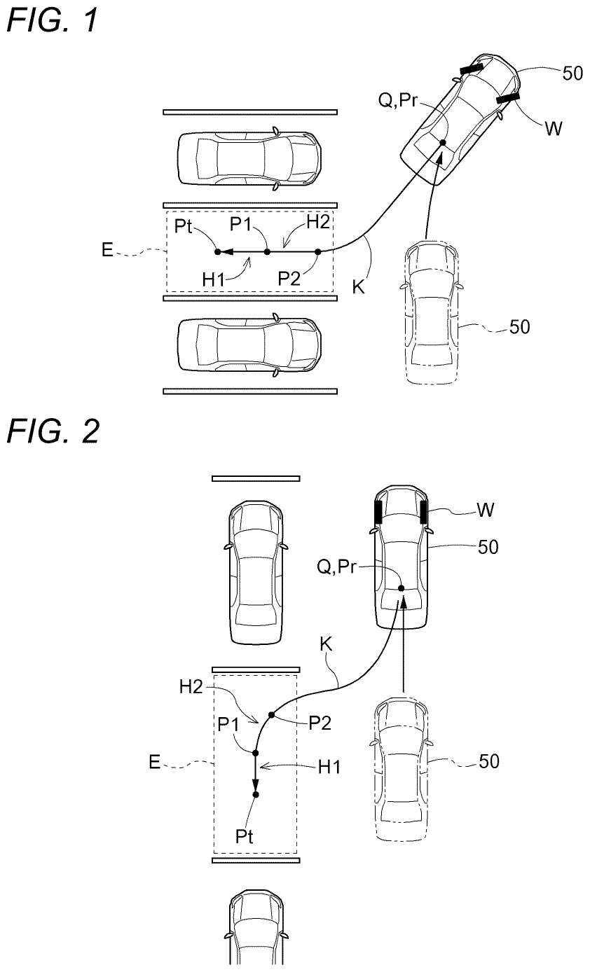

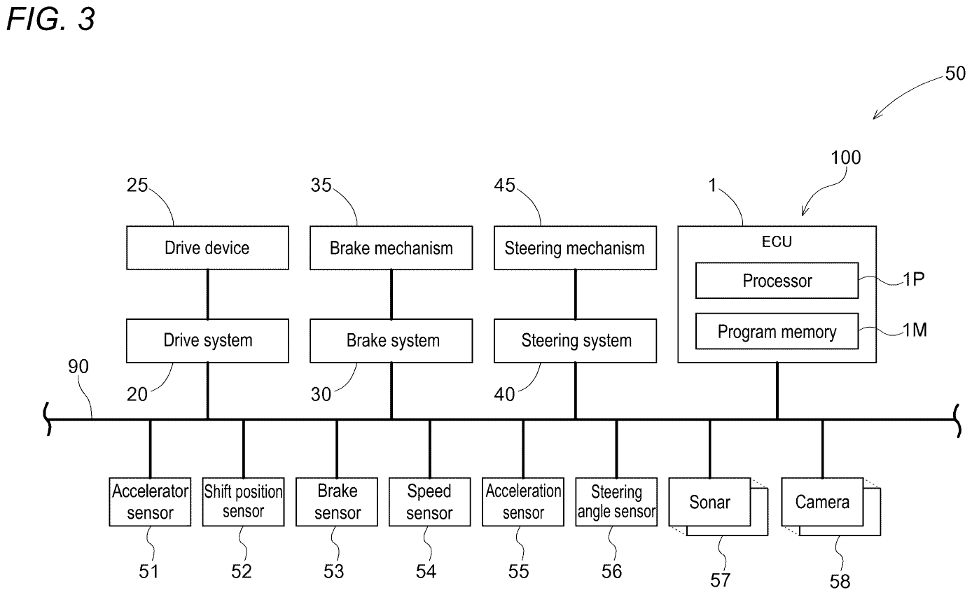

Hereinafter, an embodiment of a parking assist system will be described also with reference to the drawings. The explanatory diagrams of FIGS. 1 and 2 each illustrate one form of parking assist when a vehicle 50 is parked. In addition, the block diagram of FIG. 3 schematically illustrates an example of a system configuration of a vehicle 50 including a parking assist system 100. The parking assist system 100 of the present embodiment performs vehicle control for moving the vehicle 50 to a parking space E by controlling a driving force and a braking force acting on a wheel W and controlling a steering angle. In the present embodiment, the parking assist system 100 parks the vehicle 50 in the parking space E by automatic driving. However, a form may be employed in which semi-automatic driving is performed, that is, steering may be manually performed by the driver based on guidance by the parking assist system 100, and only driving and braking may be performed by automatic driving.

As illustrated in FIG. 3, the parking assist system 100 is implemented by cooperation of an electronic control unit (ECU) 1 as a core with other systems and various sensors. The ECU 1 corresponds to a vehicle control unit that performs vehicle control. The ECU 1 includes: a processor 1P such as a microcomputer, a microprocessor, or a digital signal processor (DSP); a program memory 1M in which software such as a program and parameters is stored; and other various electronic components. The processor 1P is hardware as a core of the ECU 1, and the vehicle control unit is implemented by cooperation of the processor 1P as a core with various types of hardware and software such as a program stored in the program memory 1M.

Then, the parking assist system 100 is implemented, with the ECU 1 as the core, by cooperation of (i) other systems such as a drive system 20, a brake system 30, and a steering system 40, (ii) various sensors and peripheral devices denoted by reference signs “51” to “58”, and (iii) the ECU 1. Various functional units constituting the parking assist system 100 will be described below, and each functional unit may be implemented by a plurality of pieces of hardware or may be implemented by cooperation of at least one piece of hardware and software, and is not necessarily configured as an independent component.

As illustrated in FIGS. 1 and 2, on the basis of a target parking position Pt set in the parking space E and a current position Pr of the vehicle 50, the parking assist system 100 moves the vehicle 50 to the target parking position Pt and then stops the vehicle 50. The target parking position Pt and the current position Pr correspond to coordinates in a coordinate system (parking assist coordinate system) when the parking assist system 100 performs parking assist (vehicle control). Note that the parking assist coordinate system may be absolute coordinates (world coordinate system) for the entire earth, or may be a local coordinate system for an area such as an area around the vehicle 50 or the parking space E, an area of the entire parking lot including the parking space E, or an area including the parking lot.

The reference sign “Q” illustrated in FIGS. 1 and 2 indicates a reference point in the vehicle 50 when the position of the vehicle 50 is specified. In addition, the current position Pr corresponds to the coordinates where the reference point Q is located in the parking assist coordinate system. The target parking position Pt represents the coordinates where the reference point Q of the vehicle 50 is located when the vehicle 50 is appropriately located in the parking space E. The parking assist system 100 calculates a movement trajectory of the reference point Q when the vehicle 50 moves from the current position Pr to the target parking position Pt on the basis of the current position Pr and the target parking position Pt, and sets the movement trajectory as a movement route K. The parking assist system 100 performs vehicle control such that the reference point Q moves from the current position Pr along the movement route K. When the reference point Q reaches the target parking position Pt, that is, when the current position Pr matches the target parking position Pt, it means that the vehicle 50 is appropriately located in the parking space E, and the parking assist system 100 therefore stops the vehicle 50.

In order to stop the vehicle 50 at the target parking position Pt, the ECU 1 gradually decelerates a speed of the vehicle 50 to zero in a first range H1 that is a part of the movement route K to the target parking position Pt and includes the target parking position Pt. As illustrated in FIGS. 1 and 2, the first range H1 is a part of the movement route K and is a range from a first position P1 to the target parking position Pt. Note that, in the present embodiment, the ECU 1 decelerates the speed of the vehicle 50 also in a second range H2 that is farther, on the movement route K, from the target parking position Pt than the first range H1 is. As illustrated in FIGS. 1 and 2, in the present embodiment, the second range H2 is a part of the movement route K and is a range from a second position P2 to the first position P1. In the present embodiment, the first range H1 and the second range H2 are continuous with each other on the movement route K. Therefore, the speed of the vehicle 50 at the start of traveling in the first range H1 is the same as the speed of the vehicle 50 at the end of traveling in the second range H2.

FIG. 1 exemplifies so-called garage parking. For example, the driver passes by the parking space E, steers the vehicle 50 in a direction opposite to the parking space E, and stops the vehicle 50 in such a state that the vehicle 50 is slightly turned. This position can be referred to as a backward movement start position at which the vehicle 50 starts to move backward toward the parking space E. Note that, although an amount of steering required at the time of movement to the target parking position Pt becomes larger, the vehicle 50 may not be steered as described above and be stopped in a straight traveling state as in FIG. 2. Furthermore, the direction of steered wheels may be changed by so-called stationary steering in cooperation with the steering system 40 before starting a movement from the stop position to the target parking position Pt.

FIG. 2 exemplifies so-called parallel parking. Also in this case, for example, the driver stops the vehicle 50 after passing by the parking space E. Although FIG. 2 exemplifies a form in which the vehicle 50 is stopped in a state where the vehicle 50 is not steered, the vehicle 50 may be stopped in a state where the vehicle is steered in a direction opposite to the parking space E in a similar manner to FIG. 1.

Note that, in a case where the driver moves the vehicle 50 forward, it is preferable that the parking assist system 100 guide a traveling direction and the stop position (backward movement start position). For example, it is preferable that the driver be guided by display on a display in a cabin or voice guidance and that the driver operate an accelerator pedal, a brake pedal, a steering wheel, and the like (none of which is illustrated) to move the vehicle 50 to the backward movement start position.

In one form, when the vehicle 50 reaches the backward movement start position, the parking assist system 100 notifies the driver that automatic driving including automatic steering is possible. When the driver instructs start of vehicle control by touching a start button provided on, for example, a touch panel on the display in the cabin, a driving operation of the vehicle 50 including steering is handed over to the parking assist system 100, and the parking assist system 100 moves the vehicle 50 to the target parking position Pt by automatic driving.

Here, a form in which the driver advances the vehicle 50 up to the backward movement start position has been exemplified. However, it is not precluded that the parking assist system 100 performs vehicle control (parking assist) so as to cause the vehicle 50 to travel by automatic driving before the vehicle 50 reaches the backward movement start position, in other words, before or when the vehicle 50 is moving forward toward the backward movement start position.

The vehicle control targeted by the present embodiment is control for moving the vehicle 50 from the backward movement start position to the target parking position Pt. Therefore, the driving assist system controls the driving force and the braking force acting on the wheel W and, preferably, additionally controls the steering angle, whereby the driving assist system moves the vehicle 50 to the target parking position Pt and then stops the vehicle 50, based on the target parking position Pt set in the parking space E and the current position Pr of the vehicle 50. The backward movement start position can be referred to as an initial value of the current position Pr of the vehicle 50. As described above, the vehicle control is not limited to a form in which all of driving, braking, and steering are automatically performed, and the vehicle control may be performed using semi-automatic driving in which only driving and braking are performed by automatic driving, and steering is manually performed by the driver.

Although the present description exemplifies a form in which the vehicle 50 is moved to the parking space E by backward movement, a form is not precluded in which the vehicle 50 is moved to the parking space E by forward movement. Therefore, the vehicle control targeted by the present embodiment corresponds to control in which, when the vehicle control is performed by automatic driving to move the vehicle to the target parking position Pt without stopping the vehicle 50, the vehicle 50 is moved to the target parking position Pt from the position where the vehicle 50 temporarily stops before starting to move to the parking space E. Then, the position where the vehicle 50 is temporarily stopped can be referred to as an initial value of the current position Pr of the vehicle 50.

As illustrated in the schematic block diagram of FIG. 3, the vehicle 50 includes the drive system 20, the brake system 30, and the steering system 40, in addition to the ECU 1 serving as a core of the parking assist system 100. The drive system 20 is a system that controls the drive device 25 that drives the wheel W. The drive device 25 includes an engagement device and the like that connect and disconnect power transmission among, for example, an internal combustion engine, a rotary electric machine, a gear mechanism, and a rotary member (none of which is illustrated). The brake system 30 is a system that generates a braking force on the wheel W. The steering system 40 is a system that changes a traveling direction of the vehicle 50 by moving steered wheels among the wheels W.

The vehicle 50 also includes various sensors and peripheral equipment such as an accelerator sensor 51, a shift position sensor 52, a brake sensor 53, a speed sensor 54, an acceleration sensor 55, a steering angle sensor 56, sonars 57, and cameras 58. The accelerator sensor 51 is a sensor that detects an operation amount of the accelerator pedal by the driver. The shift position sensor 52 is a sensor that detects an instruction input instructing an operation mode of the drive device 25 such as a gear position (also including rear, parking, and the like) instructed by a shift lever (not illustrated). The brake sensor 53 is a sensor that detects an operation amount of the brake pedal by the driver. The speed sensor 54 is a sensor that detects a traveling speed of the vehicle 50, that is, a rotation speed of the wheel W. The acceleration sensor 55 is a sensor that detects an acceleration of the vehicle 50, and the acceleration sensor 55 of the present embodiment can also detect, for example, an inclination angle and an inclination direction of the ground on which the vehicle 50 is located. The steering angle sensor 56 is a sensor that detects an operation amount of the steering wheel by the driver, and preferably detects the operation amount as a steering angle of the vehicle 50. The sonars 57 are installed at a plurality of locations on the vehicle 50, and detect the presence or absence of an obstacle present around the vehicle 50. Preferably, the sonars 57 are active sonars. Furthermore, not only the sonars 57 but also laser radars or the like may be provided as an obstacle sensor. The cameras 58 are installed at a plurality of locations on the vehicle 50, and acquire peripheral images of the vehicle 50. Although not illustrated in FIG. 3, it is preferable that the vehicle 50 include an image processing system that functions as follows. The image processing system identifies the parking space E in which another vehicle is not stopped and in which the vehicle 50 can be parked, by image recognition of the presence or absence of an obstacle around the vehicle 50 on the basis of the peripheral images or by image recognition of a section line or the like that divides the parking space E.

The sensors and the peripheral equipment denoted by reference signs “51” to “58” including the above-described ECU 1 (parking assist system 100), the drive system 20, the brake system 30, and the steering system 40 are communicably connected to each other via an in-vehicle network 90 such as a controller area network (CAN). For example, the drive system 20 controls, via the in-vehicle network 90, the drive device 25 in cooperation with the accelerator sensor 51, the shift position sensor 52, the brake sensor 53, the speed sensor 54, the acceleration sensor 55, the steering angle sensor 56, and the like. The brake system 30 controls a brake mechanism 35 in cooperation with the brake sensor 53 via the in-vehicle network 90. The steering system 40 controls a steering mechanism 45 including the steering wheel, the steered wheels, and the like in cooperation with the steering angle sensor 56. In the present embodiment, the brake mechanism 35 and the steering mechanism 45 are driven by an actuator, and are configured using a so-called by-wire system via the in-vehicle network 90.

Furthermore, the drive system 20, the brake system 30, and the steering system 40 can also cooperate with the sonars 57 and the cameras 58 (image processing system). In addition, the ECU 1 cooperates with the drive system 20, the brake system 30, the steering system 40, the image processing system, and the sensors and the peripheral equipment denoted by reference signs “51” to “58”. In a case where the ECU 1, which is the core of the parking assist system 100, cooperates with these systems, sensors, and peripheral equipment, such cooperating systems, sensors, and peripheral equipment are also included in the parking assist system 100.

Furthermore, position information (current position Pr) of the vehicle 50 is identified by, for example, a global positioning system (GPS) (not illustrated), identification of a relative position between the parking space E and the vehicle 50 by image recognition performed by the image processing system, or communication between a transmitter (not illustrated) in the parking lot and a receiver (not illustrated) mounted on the vehicle 50. As a matter of course, the position information of the vehicle 50 may be identified by combining a plurality of these. In addition, the coordinates and the like of the target parking position Pt in the parking space E are preferably stored as map information in a database (storage medium) (not illustrated) mounted on the vehicle 50. Note that the map information may be fixedly stored in the database of the vehicle 50, or may be downloaded by communication or the like when parking is assisted.

As described above, in the present embodiment, the parking assist system 100 performs vehicle control for moving the vehicle 50 from the backward movement start position (temporary stop position, initial value of the current position Pr) to the target parking position Pt. Between these positions, the vehicle 50 is automatically driven.

Then, as described above, in order to stop the vehicle 50 at the target parking position Pt, the ECU 1 gradually decelerates the speed of the vehicle 50 to zero in the first range H1 including the target parking position Pt. Furthermore, note that, in the present embodiment, the ECU 1 decelerates the speed of the vehicle 50 also in the second range H2 that is farther from the target parking position Pt than the first range Hl is.

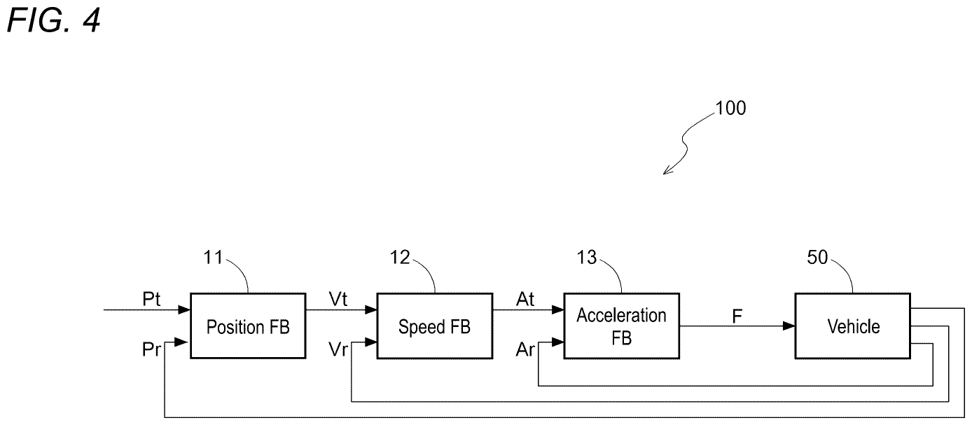

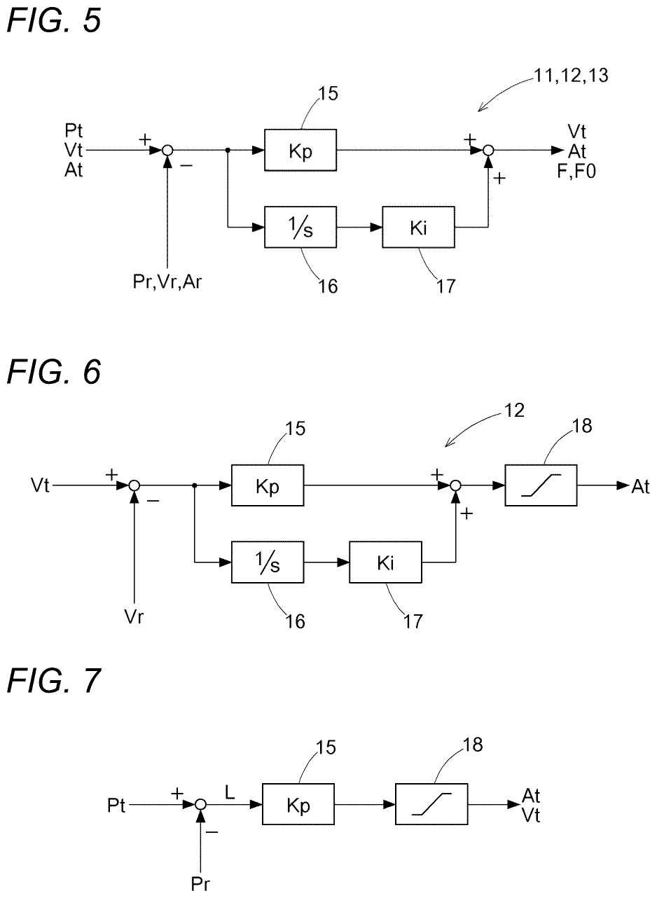

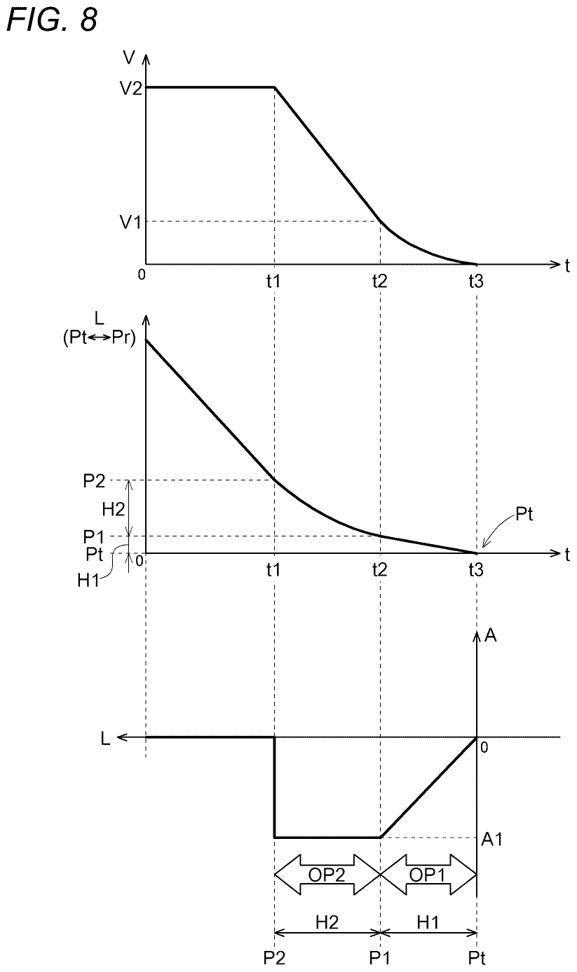

At the time of deceleration, it is preferable to quickly decrease the traveling speed of the vehicle 50 and to thereby quickly complete the parking assist, and, at the same time, it is preferable to suppress a shock such as vibration to be small when the vehicle 50 stops at the target parking position Pt. The parking assist system 100 of the present embodiment is configured to more smoothly stop the vehicle 50 at the target parking position Pt when performing vehicle control for moving the vehicle 50 to the parking space E. Hereinafter, a description will be given also with reference to the block diagram of FIG. 4, the block line diagrams of FIGS. 5 to 7, and the time chart of FIG. 8.

As described above, the parking assist system 100 in which various systems, sensors, and peripheral equipment cooperate with the ECU 1 (vehicle control unit) includes the speed sensor 54 as a speed detection unit that detects a real speed that is an actual speed of a vehicle. The ECU 1 performs: speed control processing of controlling a speed of the vehicle 50 by calculating a target speed Vt for moving the vehicle 50 to the target parking position Pt set in the parking space E and then stopping the vehicle 50; and drive control processing of controlling the driving force and the braking force acting on the wheel W so as to cause the real speed Vr to become closer to the target speed Vt. The speed control processing includes: first operation processing OP1 performed in the first range H1 that is a part of the movement route K to the target parking position Pt and includes the target parking position Pt; and second operation processing OP2 performed in the second range H2 that is farther, on the movement route K, from the target parking position Pt than the first range H1 is. In the second operation processing OP2, the ECU 1 decreases the target speed Vt at a constant deceleration. Furthermore, in the first operation processing OP1, the ECU 1 decreases the target speed Vt according to a remaining distance L that is a distance, on the movement route K, between the target parking position Pt and the vehicle 50.

Note that the driving force is mainly realized by the drive device 25 via the drive system 20, and the braking force is mainly realized by the brake mechanism 35 via the brake system 30. For example, the driving force is output from an internal combustion engine, a rotary electric machine, or a hybrid drive device in which an internal combustion engine and a rotary electric machine are combined, which are included in the drive device 25. The brake mechanism 35 includes a wheel brake provided on the wheel W, and the braking force is also realized by, in addition to the wheel brake, a brake provided in a drive transmission system of the drive device 25, a negative torque of the rotary electric machine, and an engine brake of the internal combustion engine.

As illustrated in FIG. 4, the parking assist system 100 includes, as feedback controllers, a position feedback controller 11 (position FB), a speed feedback controller 12 (speed FB), and an acceleration feedback controller 13 (acceleration FB). The position feedback controller 11 calculates, based on the target parking position Pt and the current position Pr of the vehicle 50, a target speed Vt according to a movement distance from the current position Pr to the target parking position Pt through, for example, the movement route K. The speed feedback controller 12 calculates a target acceleration At for moving the vehicle 50 at the target speed Vt, based on the target speed Vt and a real speed Vr. The acceleration feedback controller 13 calculates, based on the target acceleration At and a real acceleration Ar, a working force F for accelerating or decelerating the vehicle 50 at the target acceleration At. The working force F is the driving force and the braking force acting on the wheel W. In general, when the vehicle 50 is accelerated, the working force F is a driving force, and when the vehicle 50 is decelerated, the working force F is a braking force.

As described above, the driving force is mainly realized by the drive device 25, and the braking force is mainly realized by the brake mechanism 35. Therefore, the working force F calculated by the acceleration feedback controller 13 can be referred to as a target working force that is a target value of the driving force and the braking force acting on the wheel W. Furthermore, as described above, in addition to the speed sensor 54 as the speed detection unit that detects the real speed Vr that is the actual speed of the vehicle 50, the parking assist system 100 includes the acceleration sensor 55 as an acceleration detection unit that detects the real acceleration Ar that is the actual acceleration of the vehicle 50. The ECU 1 performs speed feedback processing of calculating the target acceleration At, based on a difference between the target speed Vt and the real speed Vr calculated in the speed control processing. At the same time, in the drive control processing of controlling the driving force and the braking force acting on the wheel W, the ECU 1 performs acceleration feedback processing of calculating the working force F (driving force, braking force) of the vehicle 50, based on a difference between the target acceleration At and the real acceleration Ar. The working force F can also be referred to as the target working force for causing the drive device 25 and the brake mechanism 35 to output the driving force and the braking force via the drive system 20 and the brake system 30.

The ECU 1 (vehicle control unit) can guide the vehicle and then stop the vehicle at the target parking position Pt by calculating the working force F serving as the target value of the driving force and the braking force acting on the wheel W, based on the real speed Vr and the target speed Vt calculated by the speed control processing and by appropriately controlling the driving force and the braking force.

FIGS. 5 and 6 each illustrate a block line diagram of the feedback controller. In the present embodiment, every one of the position feedback controller 11, the speed feedback controller 12, and the acceleration feedback controller 13 is configured as a PI controller that performs proportional-integral control. As illustrated in FIGS. 5 and 6, each of the feedback controllers includes a proportional gain 15 (Kp), an integral controller 16 (1/s), and an integral gain 17 (Ki). Of course, one or more of these controllers may be configured with a PID controller that performs proportional-integral-derivative control.

As illustrated in the block line diagram of FIG. 5, the position feedback controller 11 performs proportional control and integral control on a difference between the target parking position Pt and the current position Pr, thereby calculating the target speed Vt. The speed feedback controller 12 performs proportional control and integral control on a difference between the target speed Vt and the real speed Vr, thereby calculating the target acceleration At. The acceleration feedback controller 13 performs proportional control and integral control on a difference between the target acceleration At and the real acceleration Ar, thereby calculating the working force F.

Generally, the speed control processing of controlling the speed of the vehicle 50 by calculating, by the position feedback controller 11 and the speed feedback controller 12, the target speed Vt for moving the vehicle 50 to the target parking position Pt set in the parking space E and then stopping the vehicle is performed, and the drive control processing of controlling the driving force and the braking force acting on the wheel W is performed by the acceleration feedback controller 13 so that the real speed Vr becomes closer to the target speed Vt.

In the present embodiment, the first operation processing OP1 and the second operation processing OP2 are selectively performed as a result by the common speed feedback controller 12. Although details will be described later with reference to FIGS. 6 and 7, substantially, the first operation processing OP1 is performed in both the first operation processing OP1 and the second operation processing OP2. When the target acceleration At calculated in the first operation processing OP1 has a value within a range set in a limiter 18 to be described later, the value calculated in the first operation processing OP1 is used as the target acceleration At as it is. On the other hand, when the target acceleration At calculated in the first operation processing OP1 is out of the range set in the limiter 18, a clip value limited to the range set in the limiter 18 is used as the target acceleration At. The target acceleration At in this case can be referred to as a value calculated by the second operation processing OP2. That is, the second operation processing OP2 corresponds to an operation when the limiter 18 acts, and the first operation processing OP1 corresponds to an operation when the limiter 18 does not act.

In order to perform the first operation processing OP1 and the second operation processing OP2 in this manner, the speed feedback controller 12 further includes the limiter 18 as illustrated in FIG. 6. As described above, in the first operation processing OP1, the ECU 1 decreases the target speed Vt according to the remaining distance L that is the distance, on the movement route K, between the target parking position Pt and the current position Pr of the vehicle 50. Furthermore, in the second operation processing OP2, the ECU 1 decreases the target speed Vt at a constant deceleration (acceleration). A deceleration limit value A1 (see FIG. 8) in the limiter 18 corresponds to the constant deceleration in the second operation processing OP2.

The block line diagram of FIG. 7 schematically illustrates a principle of the control of the deceleration (acceleration) based on the remaining distance L in the ECU 1. For the sake of simplicity, integration blocks (integral controller 16 and integral gain 17) are omitted, and only a proportional block (proportional gain 15) is illustrated. As illustrated in FIG. 7, based on the remaining distance L that is the difference between the target parking position Pt and the current position Pr on the movement route K, the ECU 1 calculates, for example, an initial value of the target acceleration At proportional to the remaining distance L, and outputs the initial value via the limiter 18. When the initial value is within the range limited by the limiter 18, the initial value is output as the target acceleration At. That is, the target acceleration At corresponding to the remaining distance L, that is, the target acceleration At proportional to the remaining distance L is output in this case. When the initial value exceeds the range limited by the limiter 18, the initial value is clipped to a maximum value or a minimum value of the limit range, and the maximum value or the minimum value is output as the target acceleration At. That is, the target acceleration At (=the deceleration limit value A1) having a constant value is output regardless of the remaining distance L.

Note that, it is described in the above that, when the initial value is within the limit range of the limiter 18, the initial value is output as it is as the target acceleration At and that, when the initial value exceeds the limit range of the limiter 18, the value clipped to the deceleration limit value A1 is output as the target acceleration At.

However, the following operation is substantially the same. When the initial value is less than the limit range of the limiter 18, the initial value is output as it is as the target acceleration At and that, when the initial value is equal to or greater than the limit range of the limiter 18, the value clipped to the deceleration limit value A1 is output as the target acceleration At. Therefore, the terms “equal to or greater than”, “equal to or less than”, “less than”, and “exceed” are not strictly applied.

In the time chart of FIG. 8, “V” on the vertical axis represents the speed V (target speed Vt or real speed Vr) of the vehicle 50, “L” on the vertical axis and the horizontal axis represents the remaining distance L, “A” on the vertical axis represents the acceleration A (target acceleration At or real acceleration Ar) of the vehicle 50, and “t” on the horizontal axis represents time. The time chart in the upper part of FIG. 8 illustrates the relationship between the speed V of the vehicle 50 and time, the time chart in the middle part illustrates the relationship between the remaining distance L and time, and the time chart in the lower part illustrates the relationship between the acceleration A (deceleration) and the remaining distance L.

As illustrated in the time chart on the upper part, the vehicle 50 travels at a constant speed “V2” until time t1, and decelerates at a constant deceleration (negative acceleration A) from time t1 to time t2. After time t2, the vehicle 50 decelerates at a deceleration (negative acceleration A) whose absolute value is smaller than that in the period from time t1 to time t2 and becomes gradually smaller, and the speed V then becomes zero at time t3.

In the period until time t1, the acceleration A is zero as illustrated in the time chart in the lower part, and the speed V is a constant speed “V2” as illustrated in the time chart in the upper part. When the vehicle 50 reaches the second position P2, the ECU 1 calculates the acceleration A for deceleration. As illustrated in FIG. 1 and the like, at this time, the remaining distance L is relatively long; therefore, the value of the deceleration according to the remaining distance L is large. Therefore, the acceleration A is clipped to the lower limit value “−A1” set in the limiter 18. The vehicle 50 moves from the second position P2 to the first position Pl between time t1 and time t2. That is, the vehicle 50 travels in the second range H2 from time t1 to time t2. Between time t1 and time t2 (in the second range H2 from the second position P2 to the first position P1), the speed V of the vehicle 50 decreases at a constant deceleration (negative acceleration A). As illustrated in the time chart of interruption of FIG. 8, the remaining distance L decreases more gradually from time t1 to time t2 as compared with the period until time t1.

When the vehicle 50 reaches the first position P1 at time t2, the limiter 18 does not limit the deceleration (negative acceleration A) any more, and the speed V of the vehicle 50 decreases at the deceleration that gradually decreases according to the remaining distance L (the negative acceleration A whose absolute value gradually decreases according to the remaining distance L). The speed V decreases more slowly after time t2 (first range H1) than in the period between time t1 and time t2 (second range H2). Since the speed V decreases, the remaining distance L also decreases more slowly after time t2 than in the period between time t1 and time t2.

As described above, the ECU 1 performs the speed control processing of calculating the target speed Vt and, at the same time, performs the drive control processing of controlling the working force F so that the real speed Vr becomes closer to the target speed Vt. This speed control processing includes the first operation processing OP1 performed in the first range H1 (from the first position P1 to the target parking position Pt) and the second operation processing OP2 performed in the second range H2 (from the second position P2 to the first position P1). Furthermore, as illustrated in FIG. 8, in the second operation processing OP2 performed in the period from time t1 to time t2 in which the remaining distance L is included in the second range H2, the target speed Vt decreases at a constant deceleration. In addition, in the first operation processing OP1 performed in the period from time t2 to time t3 in which the remaining distance L is included in the first range H1, the target speed Vt decreases according to the remaining distance L.

That is, in the second range H2, it is possible to cause the vehicle 50 to come closer to the target parking position Pt while rapidly decelerating the vehicle 50 at a constant deceleration (acceleration A). Then, in the first range H1 that is closer to the target parking position Pt than the second range H2 is, it is possible to gradually decrease the deceleration of the vehicle 50 according to the remaining distance L as the vehicle 50 comes closer to the target parking position Pt. Therefore, the change in the real speed of the vehicle 50 in the vicinity of the target parking position Pt is suppressed to be small, and the vibration when the vehicle 50 stops at the target parking position Pt is suppressed to be small, so that the smooth vehicle stop operation is easily achieved.

In the present embodiment, the deceleration is not set as a map value corresponding to, for example, the remaining distance L, but is obtained by calculation every time in the ECU 1. Therefore, for example, even when the real speed Vr of the vehicle 50 at time t1 varies, the vehicle 50 can be quickly and smoothly decelerated toward the target parking position Pt. When the vehicle 50 travels on the movement route K, even when the target speed Vt is constant, the real speed Vr of the vehicle 50 may vary depending on the road surface and the surrounding situation. In a case where the deceleration is set as a map value set according to the remaining distance L, it can be considered that the real speed Vr cannot be appropriately decelerated and a shock occurs at the target parking position Pt. However, as in the present embodiment, since the ECU 1 determines the deceleration by calculation, smooth deceleration can be realized. As illustrated in FIGS. 1, 2, and 8, in the present embodiment, the first range H1 and the second range H2 are continuous on the movement route K, and the target speed Vt at the time of ending the second operation processing OP2 coincides with the target speed Vt at the time of starting the first operation processing OP1. As a result, the vehicle control unit (ECU 1) can smoothly perform switching of processing at the time of starting the first operation processing OP1 from the state of performing the second operation processing OP2. Therefore, it is possible to suppress a change in behavior of the vehicle 50 due to the switching of processing from the second operation processing OP2 to the first operation processing OP1.

Furthermore, as described above, since the speed feedback controller 12 includes the limiter 18, the speed feedback controller 12 can perform substantially the same operation processing in the first range H1 and the second range H2. In other words, the second range H2 is set to such a range that, when the target speed Vt is decreased by the first operation processing OP1, the deceleration (acceleration A) of the target speed Vt is set to be equal to or greater than a preset deceleration limit value A1.

That is, the vehicle control unit (ECU 1) can perform the same first operation processing OP1 as core operation processing in both the case of setting the deceleration (acceleration A) by the first operation processing OP1 and the case of setting the deceleration by the second operation processing OP2. Furthermore, since the second range H2 is set to a range in which the deceleration of the target speed Vt is equal to or greater than the deceleration limit value A1, when the first operation processing OP1 is performed in the second range H2, the deceleration is limited to the deceleration limit value A1, and when the first operation processing OP1 is performed in the first range H1, the deceleration is set to a value calculated by the first operation processing OP1.

That is, the second operation processing OP2 is processing in a state where the deceleration is limited by the first operation processing OP1 and, in addition, by the deceleration limit value A1. Therefore, in the second range H2 in which the second operation processing OP2 is performed, even when a deceleration having a value higher than the deceleration limit value A1 is calculated by the first operation processing OP1, the deceleration is prevented from being set to be greater than the deceleration limit value A1, and the target speed Vt decreases at a constant deceleration, based on the deceleration limit value A1, which is a constant deceleration. When the value calculated by the first operation processing OP1 becomes less than the deceleration limit value A1, the limitation of the deceleration is released, and the range is smoothly shifted from the second range H2 to the first range H1 in which the first operation processing OP1 is performed. Therefore, the vehicle control unit (ECU 1) can perform vehicle control while suppressing the change in behavior of the vehicle 50 caused by switching of processing.

Note that, as described above, the vehicle 50 includes the sonars 57 installed at a plurality of locations on the vehicle 50 to detect the presence or absence of an obstacle present around the vehicle 50. In the parking assist system 100, these sonars 57 can each function as an obstacle detection unit that detects an obstacle that may come into contact with the vehicle 50. Furthermore, in a case where a laser radar or the like is provided, the laser radar can also function as the obstacle detection unit. Furthermore, as described above, the vehicle 50 may also be equipped with an image processing system that image-recognizes the presence or absence of an obstacle around the vehicle 50 on the basis of the captured images captured by the cameras 58 that are installed at a plurality of locations on the vehicle 50 and acquire peripheral images around the vehicle 50. Such an image processing system can also cooperate with the parking assist system 100, and in that case, the image processing system can function as the obstacle detection unit in the parking assist system 100.

As described above, the parking assist system 100 can further include an obstacle detection unit that detects an obstacle that may come into contact with the vehicle 50. Then, when the obstacle detection unit detects an obstacle while the vehicle 50 is moving to the parking space E, the ECU 1 preferably stops, in the speed control processing, the vehicle 50 so that the vehicle 50 stops without contacting the obstacle. For example, the following operation is preferable. Instead of the target parking position Pt, a position at which the vehicle 50 can stop without contacting the obstacle is set as a target stop position, the first range H1 and the second range H2 are set with the distance, on the movement route K, from the current position Pr to the target stop position as the remaining distance L, and the first operation processing OP1 and the second operation processing OP2 are performed.

However, depending on a position of the obstacle, when the vehicle 50 is decelerated by performing the first operation processing OP1 and the second operation processing OP2, there is a case where the vehicle 50 cannot be stopped at the target stop position. In this case, the limitation by the limiter 18 is released, and, for example, the deceleration limit value A1 is reset to such a value that no limitation is applied, whereby the vehicle 50 can be stopped such that the vehicle 50 does not come into contact with the obstacle although some shock may occur at the time of stopping.

### Other Embodiments

Other embodiments will be described below. Note that the configurations of the embodiments described below are each not limited to an embodiment that is applied alone, and can be each applied in combination with configurations of other embodiments as long as there is no contradiction.

(1) The above description has exemplified a form that includes the position feedback controller 11, the speed feedback controller 12, and the acceleration feedback controller 13, and the deceleration in the first range H1 and the deceleration in the second range H2 are made different from each other by limiting the target acceleration At serving as the target value of the deceleration in the speed feedback controller 12. However, the present disclosure is not limited to this form, and a form may be configured as follows. For example, the position feedback controller 11 includes the limiter 18 and determines the target speed Vt by limiting the change amount of the target speed Vt, so that the deceleration of the speed V (target speed Vt, real speed Vr) of the vehicle 50 is different from each other between the first range H1 and the second range H2. That is, as illustrated in the conceptual block line diagram of FIG. 7, the target acceleration At and the target speed Vt only need to be calculated according to the remaining distance L.

(2) Furthermore, the first position P1 and the second position P2 for setting the first range H1 and the second range H2 may be set based on the remaining distance L or may be set based on an expected movement time. As illustrated in FIG. 8, there is a correlation between time t1 and the second position P2 and between time t2 and the first position P1, therefore, the first range H1 and the second range H2 may be set by either the remaining distance L or time.

(3) Furthermore, although the above description has exemplified a form in which the first range H1 and the second range H2 are continuous with each other on the movement route K, the present disclosure is not limited to this form, and the first range H1 and the second range H2 may be separated from each other. Also in this case, the target speed Vt at the time of ending the second operation processing OP2 performed in the second range H2 and the target speed Vt at the time of starting the first operation processing OP1 performed in the first range H1 may match each other. In this case, the target speed Vt is preferably constant between the first range H1 and the second range H2.

As a matter of course, in the case where the first range H1 and the second range H2 are separated from each other, the target speed Vt at the time of ending the second operation processing OP2 may be different from the target speed Vt at the time of starting the first operation processing OP1. In this case, the target speed Vt at the time of starting the first operation processing OP1 is preferably lower than the target speed Vt at the time of ending the second operation processing OP2. In addition, the target speed Vt preferably decreases gradually, between the first range H1 and the second range H2, from the target speed Vt at the time of ending the second operation processing OP2 to the target speed Vt at the time of starting the first operation processing OP1. For example, in a case where a plurality of deceleration limit values can be set in the limiter 18, the target speed Vt may be decreased from the target speed Vt at the time of ending the second operation processing OP2 to the target speed Vt at the time of starting the first operation processing OP1 at a constant deceleration by using a deceleration limit value lower than the deceleration limit value A1 in the second range H2.

(4) With reference to FIG. 6, the above description has exemplified a form in which the second range H2 is set to such a range that, when the target speed Vt is decreased by the first operation processing OP1, the deceleration of the target speed Vt is set to be equal to or greater than a preset deceleration limit value A1. That is, a form has been exemplified in which substantially the same operation processing is performed in the first range H1 and the second range H2, and the first operation processing OP1 and the second operation processing OP2 are performed as a result, depending on whether the limiter 18 acts. However, the present disclosure is not limited to this configuration, and the following form may be employed. The speed feedback controller 12 includes, independently and in parallel, a control block that performs the first operation processing OP1 and a control block that performs the second operation processing OP2, and operation processing using either one of the control blocks is selectively performed.

(5) The above description has exemplified the following form. The ECU 1 performs the speed feedback processing of calculating the target acceleration At, based on the difference between the target speed Vt and the real speed Vr calculated in the speed control processing. At the same time, in the drive control processing, the ECU 1 performs the acceleration feedback processing of calculating the working force F (driving force and braking force) of the vehicle 50, based on the difference between the target acceleration At and the real acceleration Ar. That is, the description has been given by exemplifying the ECU 1 having a configuration exemplified with reference to FIGS. 4 to 6. However, the ECU 1 may be configured in a form illustrated by a different block line diagram as long as the target speed Vt is decreased at a constant deceleration by the second operation processing OP2 in the second range H2 and the target speed Vt is decreased according to the remaining distance L by the first operation processing OP1 in the first range H1.

### (Summary of Embodiments)

Hereinafter, the parking assist system (100) described in the above will be briefly summarized.

As one aspect, a parking assist system (100) includes: a vehicle control unit (1) that performs vehicle control for moving a vehicle (50) including a wheel (W) to a parking space (E) by controlling a driving force (F) and a braking force (F) acting on the wheel (W); and a speed detection unit (54) that detects a real speed (Vr) that is an actual speed of the vehicle (50). The vehicle control unit (1) performs: speed control processing of controlling a speed of the vehicle (50) by calculating a target speed (Vt) for moving the vehicle (50) to a target parking position (Pt) set in the parking space (E) and then stopping the vehicle (50); and drive control processing of controlling the driving force (F) and the braking force (F) acting on the wheel (W) so as to cause the real speed (Vr) to become closer to the target speed (Vt). The speed control processing includes: first operation processing (OP1) performed in a first range (H1) that is a part of a movement route (K) to the target parking position (Pt) and includes the target parking position (Pt); and second operation processing (OP2) performed in a second range (H2) that is farther, on the movement route (K), from the target parking position (Pt) than the first range (H1) is. The vehicle control unit (1) decreases, in the second operation processing (OP2), the target speed (Vt) at a constant deceleration, and the vehicle control unit (1) decreases, in the first operation processing (OP1), the target speed (Vt) at a deceleration whose absolute value becomes smaller as a remaining distance (L) becomes smaller, the remaining distance (L) being a distance on the movement route (K) and being between the target parking position (Pt) and the vehicle (50).

With the present configuration, in the second range (H2), it is possible to cause the vehicle (50) to come closer to the target parking position (Pt) while rapidly decelerating the vehicle (50) at a constant deceleration. Then, in the first range (H1) that is closer to the target parking position (Pt) than the second range (H2) is, it is possible to gradually decrease the deceleration of the vehicle (50) according to the remaining distance (L) as the vehicle (50) comes closer to the target parking position (Pt). Therefore, the change in the real speed (Vr) of the vehicle (50) in the vicinity of the target parking position (Pt) is suppressed to be small, and the vibration when the vehicle (50) stops at the target parking position (Pt) is suppressed to be small, so that the smooth vehicle stop operation is easily achieved. That is, with the present configuration, it is possible to achieve a parking assist system (100) capable of more smoothly stopping a vehicle (50) at a target parking position (Pt) when performing vehicle control for moving the vehicle to the parking space (E).

Here, in the first operation processing (OP1), the vehicle (50) control unit preferably decreases the target speed (Vt) at a deceleration whose absolute value is proportional to the remaining distance (L).

With this configuration, for example, it is possible to calculate the deceleration according to the remaining distance (L) without using a map or the like, but using a general-purpose proportional operation unit.

Furthermore, the following configuration is preferable. In the speed control processing, the vehicle control unit (1) of the parking assist system (100) calculates, as a target deceleration, a deceleration whose absolute value is proportional to the remaining distance (L); when the absolute value of the target deceleration is equal to or greater than an absolute value of a previously specified deceleration limit value (A1), the vehicle control unit (1) performs the second operation processing (OP2) of decreasing, regardless of the remaining distance (L), the target speed (Vt) while using the previously specified deceleration limit value (A1) as a constant deceleration; and when the absolute value of the target deceleration is less than the absolute value of the previously specified deceleration limit value (A1), the vehicle control unit (1) performs the first operation processing (OP1) of decreasing the target speed (Vt) at the target deceleration.

The vehicle control unit (1) can perform the same first operation processing (OP1) as core operation processing in both the case of setting the deceleration by the first operation processing (OP1) and the case of setting the deceleration by the second operation processing (OP2). It can be said that the second operation processing (OP2) is processing in a state where the deceleration is limited by the deceleration limit value (A1) and, in addition, by the first operation processing (OP1). Even when the deceleration having a value higher than the deceleration limit value (A1) is calculated, it is avoided that the deceleration exceeding the deceleration limit value (A1) is set, and the second operation processing (OP2) is performed in which the target speed (Vt) decreases at a constant deceleration based on the deceleration limit value (A1), which is the constant deceleration. When the calculated value is less than the deceleration limit value (A1), the limitation of the deceleration is released, and the process shifts from the second operation processing (OP2) to the first operation processing (OP1). Therefore, the vehicle control unit (1) can perform vehicle control while suppressing a change in behavior of the vehicle (50) caused by switching of processing.

Furthermore, the following configuration is preferable. The parking assist system (100) further includes an acceleration detection unit (55) that detects a real acceleration (Ar) that is an actual acceleration (A) of the vehicle (50); the vehicle control unit (1) includes a speed feedback controller (12) that performs speed feedback processing of calculating a target acceleration (At) for moving the vehicle (50) at the target speed (Vt), based on a difference between the target speed (Vt) calculated in the speed control processing and the real speed (Vr); and the first operation processing (OP1) and the second operation processing (OP2) in the speed control processing are selectively performed by the speed feedback controller (12) in common.

Since the first operation processing (OP1) and the second operation processing (OP2) can be performed by the common speed feedback controller, the configuration of the vehicle-use control unit (1) can be simplified.

Furthermore, the following configuration is preferable. The parking assist system (100) further includes an acceleration detection unit (55) that detects a real acceleration (Ar) that is an actual acceleration (A) of the vehicle (50). In a case where the vehicle control unit (1) includes a speed feedback controller (12) that performs speed feedback processing of calculating a target acceleration (At) for moving the vehicle (50) at the target speed (Vt), based on a difference between the target speed (Vt) calculated in the speed control processing and the real speed (Vr), the speed feedback controller (12) includes a proportional-integral controller (15, 16, 17) and a limiter (18); the first operation processing (OP1) and the second operation processing (OP2) in the speed control processing are selectively performed by the speed feedback controller (12) in common; and a target acceleration (At) serving as a deceleration whose absolute value is proportional to the remaining distance (L) is calculated in the speed control processing. When an absolute value of the target acceleration (At) is equal to or greater than an absolute value of a deceleration limit value (A1) specified in the limiter (18), the second operation processing (OP2) of decreasing, regardless of the remaining distance (L), the target speed (Vt) by using the deceleration limit value (A1) as a constant deceleration is performed; and when the absolute value of the target acceleration (At) is less than the absolute value of the deceleration limit value (A1), the first operation processing (OP1) of decreasing the target speed (Vt) by using the target acceleration (At) as a deceleration is performed.

### REFERENCE SIGNS LIST

1: ECU (vehicle control unit), 50: Vehicle, 54: Speed sensor (speed detection unit), 55: Acceleration sensor (acceleration detection unit), 100: Parking assist system, A: Acceleration, A1: Deceleration limit value, Ar: Real acceleration, At: Target acceleration, E: Parking space, F: Working force (driving force and braking force), FB: Acceleration, FB: Speed, H1: First range, H2: Second range, K: Movement route, L: Remaining distance, OP1: First operation processing, OP2: Second operation processing, Pt: Target parking position, V: Speed, Vr: Real speed, Vt: Target speed, and W: Wheel

1. A parking assist system comprising:
a vehicle control unit that performs vehicle control for moving a vehicle including a wheel to a parking space by controlling a driving force and a braking force acting on the wheel; and
a speed detection unit that detects a real speed that is an actual speed of the vehicle,
wherein the vehicle control unit performs:
speed control processing of controlling a speed of the vehicle by calculating a target speed for moving the vehicle to a target parking position set in the parking space and then stopping the vehicle; and
drive control processing of controlling the driving force and the braking force acting on the wheel so as to cause the real speed to become closer to the target speed,
the speed control processing includes:
first operation processing performed in a first range that is a part of a movement route to the target parking position and includes the target parking position; and
second operation processing performed in a second range that is farther, on the movement route, from the target parking position than the first range is,
the vehicle control unit decreases, in the second operation processing, the target speed at a constant deceleration, and
the vehicle control unit decreases, in the first operation processing, the target speed at a deceleration whose absolute value becomes smaller as a remaining distance becomes smaller, the remaining distance being a distance on the movement route and being between the target parking position and the vehicle.

2. The parking assist system according to claim 1, wherein in the first operation processing, the vehicle control unit decreases the target speed at a deceleration whose absolute value is proportional to the remaining distance.

3. The parking assist system according to claim 2, wherein in the speed control processing, the vehicle control unit calculates, as a target deceleration, a deceleration whose absolute value is proportional to the remaining distance,
when the absolute value of the target deceleration is equal to or greater than an absolute value of a previously specified deceleration limit value, the vehicle control unit performs the second operation processing of decreasing, regardless of the remaining distance, the target speed while using the previously specified deceleration limit value as a constant deceleration, and
when the absolute value of the target deceleration is less than the absolute value of the previously specified deceleration limit value, the vehicle control unit performs the first operation processing of decreasing the target speed at the target deceleration.

4. The parking assist system according to claim 1, further comprising an acceleration detection unit that detects a real acceleration that is an actual acceleration of the vehicle,
wherein the vehicle control unit includes a speed feedback controller that performs speed feedback processing of calculating a target acceleration for moving the vehicle at the target speed, based on a difference between the target speed calculated in the speed control processing and the real speed, and
the first operation processing and the second operation processing in the speed control processing are selectively performed by the speed feedback controller in common.
